(19) United States
(12) Patent Application Publication
(10) Pub. No.: US 2026/0253142 A1
(43) Pub. Date: Aug. 27, 2026

(54) ENHANCED UNDERWRITING READINESS THROUGH DATA DRIVEN RISK EVALUATION

(71) Applicant: Ranes, Inc., Cedar City, UT (US)

(72) Inventors: James Reed BROMLEY, Cedar City, UT (US); Karen PLANT, Doncaster, South Yorkshire (GB); James Christian MCCARTHY, Boulder, CO (US); Randall Reid GRIFFIN, Lehi, UT (US)

(21) Appl. No.: 19/537,060

(22) Filed: Feb. 11, 2026

Related U.S. Application Data
(60) Provisional application No. 63/758,930, filed on Feb. 14, 2025.

(51) Int. Cl. G06Q 40/08; G06Q 10/0635; G06Q 10/10; G06Q 40/00

(52) U.S. Cl. CPC G06Q 40/08; G06Q 10/0635; G06Q 10/10; G06Q 40/00

(57) ABSTRACT

A service maintains a persistent, standardized risk-state data structure for an organization seeking insurance coverage. The service receives claim-explanation data that supplements carrier loss records, including data provided in non-standardized formats, and converts and validates that data into the standardized structure. Using historical claim data and the claim explanations, the service applies a trained machine learning model to cluster related claims, identify underlying operational causes, and determine relevant risk-mitigating procedures. The service maps the procedures to regulatory requirements and discount-rule constraints to define verifiable compliance obligations and updates the risk-state through explicit underwriting-risk state transitions. As compliance evidence is received, the service verifies adherence and updates the risk-state accordingly. An underwriting-ready representation reflecting current risk conditions, mitigation actions, and verified compliance is generated and transmitted to a remote underwriting system, enabling an evidence-supported and continuously updated view of organizational risk.

### CROSS-REFERENCE TO RELATED APPLICATIONS

This application claims the benefit of and priority to United States Provisional Patent Application Serial No. 63/758,930 filed on February 14, 2025 and entitled “INTEGRATED AI-POWERED SAFETY PLANNING AND TASK MANAGEMENT SYSTEM,” and which application is expressly incorporated herein by reference in its entirety.

### TECHNOLOGICAL FIELD OF THE DISCLOSURE

Embodiments disclosed herein generally relate to risk management, insurance underwriting support, and transparency in evaluating and improving insurability. More particularly, at least some embodiments relate to systems, hardware, software, computer-readable media, and methods for analyzing loss-related information and regulatory requirements to guide entities in reducing risk and improving underwriting outcomes.

### BACKGROUND

Entities seeking insurance coverage traditionally rely on established underwriting practices to evaluate risk and determine eligibility for coverage. In this context, underwriting refers to the process by which an insurer assesses the likelihood and potential magnitude of loss associated with an applicant and determines whether, and under what terms, coverage can be offered. Conventional underwriting commonly depends on static questionnaires, historical loss records, periodic inspections, and manually curated guidelines derived from actuarial models and regulatory requirements. These practices are often applied at discrete points in time, such as during initial application or renewal, and can involve multiple intermediaries exchanging information through fragmented communication channels.

An underwriter is a professional, typically employed by an insurance carrier or underwriting organization, responsible for evaluating risk associated with providing insurance coverage to an applicant. The underwriter reviews information describing the applicant’s operations, assets, and prior loss history and applies underwriting guidelines to determine whether coverage can be offered and under what terms. This role commonly involves balancing risk tolerance, regulatory obligations, and business objectives while exercising professional judgment in situations where data is incomplete, inconsistent, or subject to interpretation.

In traditional insurance markets, underwriting typically begins with the collection of applicant-provided information describing the nature of the entity seeking coverage, its operations, assets, and prior loss experience. This information is commonly gathered through standardized application forms, supplemental questionnaires, and supporting documentation. A loss generally refers to a financial detriment resulting from the occurrence of an insured event, such as property damage, liability claims, or business interruption. Insurers often supplement applicant-provided information with third-party data sources, inspections, or reports prepared by specialists to further characterize exposure to potential losses.

Once information is collected, underwriting personnel compare the submitted data against internally maintained underwriting guidelines. Underwriting guidelines are predefined rules, thresholds, and qualitative criteria used by insurers to assess risk acceptability and to determine coverage terms, pricing, and conditions. These guidelines can be influenced by actuarial assumptions, historical claims data, reinsurance considerations, and legal or regulatory constraints. In many cases, underwriters exercise professional judgment when applying guidelines, particularly when information is ambiguous, incomplete, or falls outside typical risk profiles.

Underwriting decisions are often iterative and can involve multiple rounds of clarification, adjustment, or negotiation. For example, insurers can request additional information, impose exclusions, adjust deductibles, or modify coverage limits based on perceived risk characteristics. The process can also involve coordination among underwriting, actuarial, legal, and compliance functions within the insurer. Because underwriting assessments are frequently conducted on a periodic basis, such as annually, changes in an entity’s operations or external risk environment between review cycles can go unreflected until a subsequent evaluation occurs.

Traditional approaches to risk evaluation and underwriting support present several challenges. Information relevant to loss exposure, compliance status, and operational practices can be distributed across disparate sources, maintained in inconsistent formats, or updated on differing schedules. As a result, assessments can rely on incomplete, outdated, or indirectly inferred data. Additionally, underwriting criteria are frequently shaped by evolving regulatory frameworks, industry standards, and market conditions, which can be difficult for insured entities to interpret or anticipate without specialized expertise. This can lead to uncertainty regarding how specific risk factors influence coverage eligibility or underwriting decisions.

Further, conventional processes often place a significant administrative burden on both insurers and insured entities. Manual data collection, interpretation of insurer feedback, and coordination among stakeholders can introduce delays and variability in outcomes. The lack of transparency into how risk-related information is evaluated can make it difficult for organizations to understand why coverage terms change over time or which factors most materially affect underwriting determinations. These characteristics of traditional technology can complicate efforts to proactively manage risk and align organizational practices with insurer expectations.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 illustrates an example system architecture in which a service operates to maintain a risk-state data structure, ingest risk-related inputs, and generate underwriting-ready representations.

FIG. 2 illustrates how a service groups multiple claims into clusters based on shared operational attributes and associates those clusters with an identified causal nexus and operational conditions.

FIG. 3 illustrates an example scenario in which a service analyzes claims associated with a poorly lit area of a warehouse and identifies a statistical correlation between operational circumstances and loss events.

FIG. 4 illustrates a contrasting warehouse environment with adequate lighting conditions, which a service uses as a reference for distinguishing mitigated operational areas from risk-contributing areas.

FIG. 5 illustrates how a service derives risk-mitigating procedures from clustered claims and an identified causal nexus.

FIG. 6 illustrates the generation of procedure-compliance obligations based on discount-rule constraints and regulatory requirements associated with identified risk-mitigating procedures.

FIG. 7 illustrates how a service updates a persistent risk-state data structure to reflect a causal nexus, risk-mitigating procedures, and procedure-compliance obligations.

FIG. 8 illustrates how a service receives and verifies different forms of compliance-evidence data to update underwriting-risk states within the risk-state data structure.

FIG. 9 illustrates an example of sensor-generated evidence captured in a warehouse environment, including camera-based data associated with lighting conditions.

FIG. 10 illustrates an example structure of a risk-state data structure in which historical claim data is stored as time-ordered records including loss date, loss category, and claim severity.

FIG. 11 illustrates an example schema definition used by a service to map non-standardized input data into standardized fields of the risk-state data structure.

FIG. 12A illustrates a first portion of a flowchart for a method showing acts performed by a service to ingest, standardize, store, and evaluate risk-related information.

FIG. 12B illustrates a second portion of the flowchart for the method showing acts performed by a service to verify compliance evidence, update risk states, and generate underwriting-ready representations.

FIG. 13A illustrates a first portion of a flowchart for another method showing acts performed by a service to receive claim-explanation data and apply machine learning to analyze historical claims.

FIG. 13B illustrates a second portion of the flowchart for the method showing acts performed by a service to map risk-mitigating procedures to compliance obligations, verify evidence, and transmit underwriting-ready outputs.

FIG. 14 illustrates an example computing system that can be used to implement the service, including processors, storage, and network connectivity.

### DETAILED DESCRIPTION

Operationally, organizations seeking insurance coverage often lack a cohesive, system-level mechanism for maintaining an accurate and continuously verifiable representation of their risk posture. Risk-relevant information is frequently ingested in heterogeneous formats, updated asynchronously, and stored across disconnected data repositories, which can cause risk assessments to become stale or internally inconsistent over time. As operational conditions change or corrective actions are undertaken, existing systems are often unable to reflect those changes in a persistent, machine-readable state that can be programmatically evaluated and verified. This can result in repeated manual reconciliation of data, limited traceability between operational actions and underwriting outcomes, and difficulty demonstrating ongoing adherence to requirements that affect coverage eligibility.

From a system-behavior perspective, conventional tools tend to treat underwriting assessment as a sequence of isolated evaluations rather than as an evolving process governed by state transitions and verifiable evidence. Such systems commonly lack automated mechanisms for associating corrective operational measures with underlying loss drivers, enforcing consistency constraints across risk-related data, or validating compliance evidence against predefined obligations. As a result, changes intended to reduce risk can be poorly captured, inconsistently validated, or disconnected from subsequent underwriting assessments, leading to inefficiencies in data processing, uncertainty in risk-state progression, and limited ability to generate an up-to-date, evidence-supported representation of organizational risk for downstream underwriting use.

Conventional computing systems used in underwriting environments are not structured to maintain, validate, and evolve underwriting assessments as persistent machine-readable states over time. Instead, such systems typically generate static outputs that must be repeatedly recomputed as new information becomes available, leading to redundant processing, inconsistent data representations, and increased computational overhead. The disclosed techniques address these limitations by re-architecting how risk information is stored, processed, and updated within a computing environment.

The disclosed embodiments are beneficially designed to address the operational and system-level problems described above. For instance, at least some of the disclosed embodiments provide a computer-based way to keep an organization’s insurance risk information current, consistent, and verifiable as conditions change over time. These embodiments can collect risk-related information from many sources, even when the information arrives in different formats and can convert that information into a standardized record that is maintained as a persistent risk state. By analyzing historical claims together with additional explanatory details, the embodiments can help identify underlying operational conditions that contribute to losses and can link those conditions to specific actions that reduce future risk. As the organization carries out those actions, the embodiments can receive and verify electronic evidence of completion and can automatically update the risk state, producing a clear and up-to-date risk profile that can be shared with underwriters as an evidence-supported view of current risk and compliance.

Accordingly, the disclosed embodiments bring about numerous benefits, advantages, and practical applications to the technical field of computer-implemented risk management, insurance underwriting support, and compliance verification. At least some of the disclosed embodiments enable risk-related information from heterogeneous sources to be normalized into a standardized, persistent data structure that can be automatically processed and updated over time. This supports continuous, machine-verifiable evaluation of risk conditions rather than episodic or static assessments. By maintaining risk information as an evolving data state and associating that state with verifiable evidence, the disclosed embodiments provide a practical application of computing technology that enables ongoing electronic monitoring, validation, and representation of organizational risk in a manner that cannot be reliably performed using manual processes alone.

At least some of the disclosed embodiments also improve the functioning of the computer systems involved by modifying how risk-related data is stored, processed, and transmitted. The use of a persistent risk-state data structure (i.e. a computer-maintained data structure representing discrete underwriting-risk states and transitions over time) in a standardized format reduces redundant data conversions and repeated data retrieval operations, which can lower processing latency and improve overall system efficiency. Automated validation and consistency enforcement at the time of data ingestion can prevent propagation of inconsistent or incomplete data through downstream processing stages, reducing the need for corrective reprocessing. Additionally, updating risk information through state transitions, rather than recreating independent assessments, can reduce memory usage and computational overhead associated with repeated full evaluations.

Further, at least some of the disclosed embodiments improve data flow and network utilization by generating and transmitting underwriting-ready representations that are already structured and machine-readable. This can reduce bandwidth consumption and parsing complexity for downstream systems, since underwriters or underwriting platforms can directly ingest the transmitted data without manual intervention or reformatting. The automated verification of compliance evidence and corresponding updates to the risk state also enable timely propagation of changes across interconnected systems, supporting near-real-time synchronization of risk information. Collectively, these features demonstrate practical applications of computer technology that enhance data integrity, processing efficiency, and system interoperability while providing a concrete technical solution to managing dynamic, evidence-based risk information.

By encoding underwriting assessments as explicit state transitions within a persistent data structure, the disclosed techniques reduce repeated full-dataset evaluations and enable incremental computation. This improves processor efficiency and memory utilization by allowing the computing system to update only affected portions of the risk state rather than regenerating entire assessments.

Accordingly, the disclosed embodiments provide a computer-based approach for maintaining a continuously updated and verifiable representation of an organization’s insurance risk by standardizing and persistently managing risk-related data from multiple sources. At least some of the disclosed embodiments convert non-uniform inputs into a structured risk state, automatically evaluate that state using defined logic, and update it based on verified evidence of risk-mitigating actions. By treating risk assessment as an evolving, data-driven process rather than a static review, the disclosed embodiments enable efficient, machine-readable communication of current risk conditions and compliance status to downstream underwriting systems.

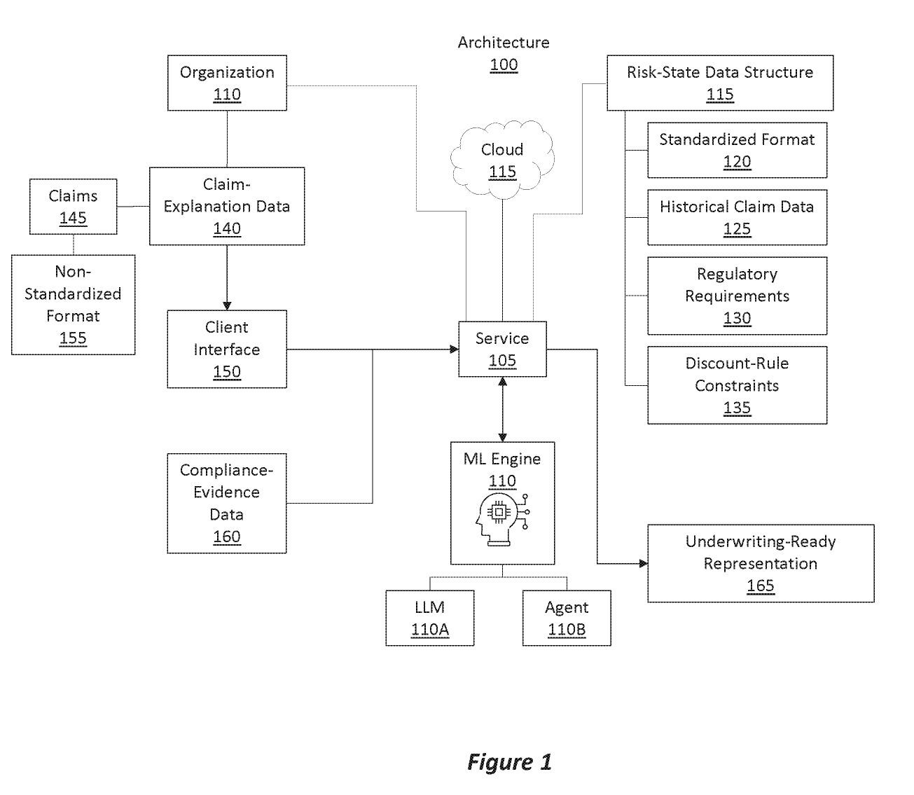

With that understanding, attention will now be directed to FIG. 1, which illustrates an example computing architecture 100 in which the disclosed principles may be employed. Architecture 100 shows a service 105.

As used herein, the term “service” refers to an automated program that is tasked with performing different actions based on input. In some cases, service 105 can be a deterministic classifier that operates fully given a set of inputs and without a randomization factor. In other cases, service 105 can be or can include a machine learning (ML) or artificial intelligence engine, such as ML engine 110. The ML engine 110 enables service 105 to operate even when faced with a randomization factor. ML engine 110 can include any type of large language model (LLM) 110A or LLM agent 110B.

An LLM is a type of artificial intelligence system trained on vast amounts of textual data using self-supervised learning techniques. These models, often built on transformer architectures like generative pre-trained transformer (GPT), are designed to understand, generate, and manipulate human language with remarkable fluency. LLMs can perform a wide range of tasks such as answering questions, translating languages, writing code, summarizing documents, and even generating creative content. They serve as the core intelligence behind many modern AI applications, including chatbots, virtual assistants, and content generation tools. In more advanced implementations, LLMs are embedded within autonomous agents that can use memory, tools, and APIs to perform complex tasks beyond simple text generation.

An LLM (e.g., LLM 110A) is a specialized type of ML or AI model that has been trained on a large set of data. The data can be of any type, though it is often text-based data. Image data, video data, audio data, and other data types can also be used. With its training, the LLM is able to understand and produce output that resembles human-generated output. As various examples, an LLM can be tasked with translating input from one language (e.g., perhaps English) to another language (e.g., perhaps Spanish). LLMs can be tasked with answering questions, writing code, analyzing language patterns, generating images, generating videos, and writing creative content.

An “agent” (e.g., agent 110B) is a type of system or service that leverages one or more LLMs to perform a task, which refers to a unit of work that needs to be performed. Notably, an agent is a type of autonomous system that can “think” and act on its own; meaning, it can operate without specific instructions from a user. An LLM will respond to a question if asked. For instance, if an LLM is asked: “What is the price of a plane ticket to Machu Picchu?” the LLM can generate a response. An agent, on the other hand, can not only provide a response, but it can also go about scheduling and paying for the flight. The agent can also book a hotel and vehicular travel arrangements. An LLM functions as a computational tool whereas an agent functions as an autonomous operator; essentially an agent can use LLMs to accomplish tasks.

An agent operates on top of an LLM in that the agent can use the LLM to complete its tasks. An agent also includes memory and tools or functionality. Using its memory, the agent can recall information from past sessions. Using its tools, the agent can facilitate the completion of tasks. Agents can have access to external databases, application programming interfaces (API), or any other utility. At its highest level of description, however, an agent can be viewed as being an executable service or component having access to an LLM that operates at the core of the agent. The LLM helps to process information and to assist in deciding what decisions will be taken by the agent. Additional memory, action-taking skills, or tools can be plugged into the agent to further expand its functionality.

As used herein, the terms “service” (e.g., service 105), “LLM” (e.g., LLM 110A), or “LLM agent” (e.g., agent 110B) or, more simply “agent,” can be used interchangeably with one another. Thus, if reference is made to a scenario where the service 105 is performing an action, one will appreciate how the phrases “LLM,” “agent,” or “LLM agent” could have been used. Likewise, if reference is made to a scenario where the LLM agent 110B is performing an action, one will appreciate how the terms “service,” “LLM,” or “agent” could have been used. In this manner, these terms are used interchangeably, though it is recognized that there can be some differences between a service, an LLM, and an agent, as mentioned earlier. That is, in some implementations, these terms may refer to distinct components with different operational roles.

As used herein, reference to any type of machine learning or artificial intelligence (or LLM) may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 105 is a local service operating on a local device, such as an edge device. In some implementations, service 105 is a cloud service operating in a cloud 120 environment. In some implementations, service 105 is a hybrid service that includes a cloud component operating in the cloud 120 and a local component operating on a local device. These two components can communicate with one another.

Service 105 is generally tasked with generating a stateful, dynamically verifiable underwriting improvement model for an organization seeking insurance coverage. Service 105 maintains, for an organization 110 seeking insurance coverage, a persistent risk-state data structure 115 that is stored in a standardized format 120 and continuously available for processing. This risk-state data structure 115 includes historical claim data 125, regulatory requirements 130 applicable to the organization 110, and carrier-specific discount and credit rules (collectively referred to as discount-rule constraints 135) sourced from curated, containerized datasets. Service 105 can manage this data structure as a long-lived digital record that evolves over time rather than as a temporary or transactional dataset, allowing subsequent operations to reference prior states and transitions.

In some implementations, service 105 stores historical claim data 125 as time-ordered records, with each record including a loss date, a loss category, and an indicator of claim severity. This temporal ordering allows the service to analyze patterns across time and correlate operational changes with changes in loss behavior. Service 105 can also encode regulatory requirements as machine-readable compliance rules that reflect jurisdiction-specific safety, reporting, or operational standards, enabling automated evaluation without manual interpretation. Carrier-specific discount and credit rules can be maintained as versioned datasets, and service 105 can select an appropriate dataset version based on a particular insurance carrier or coverage type, which allows service 105 to adapt its processing as carrier programs change over time.

Service 105 receives claim-explanation data 140 for specific claims 145 through a client interface 150, with the claim-explanation data 140 being supplied by the organization 110 to describe operational circumstances surrounding individual historical claim data 125, of which the claims 145 are a part. The claim-explanation data 140 can supplement or clarify details that are missing or ambiguous in carrier-provided loss-run records. At least some of this information can arrive in non-standardized formats (e.g., non-standardized format 155) that vary based on the source platform, data-entry mechanism, or originating system.

To integrate the claim-explanation data 140, service 105 converts the non-standardized data into the standardized data format 120 used by the persistent risk-state data structure 115. This conversion can include mapping source-specific data fields to predefined standardized fields using a stored schema definition, enabling consistent downstream processing. During conversion, service 105 validates the claim-explanation data 140 against defined constraints and can enforce cross-field consistency rules that prevent mutually incompatible risk attributes from being stored together. These validation steps help ensure that the risk-state data structure 115 remains internally coherent and suitable for automated analysis.

After conversion and validation, service 105 stores the normalized/converted claim-explanation information 140 together with the historical claim data 125 in the persistent risk-state data structure 115. This combined storage allows service 105 to treat factual loss data and contextual explanations as part of a unified risk record rather than as separate, disconnected inputs. Service 105 can retain both original and derived representations to support traceability and later review.

Once the data is stored, service 105 processes the historical claim data 125 together with the claim-explanation data 140 using a trained ML model (e.g., ML engine 110). The model can be trained using historical claim datasets associated with multiple organizations and labeled with operational attributes drawn from prior loss events. The ML model can: operate in supervised, unsupervised, or semi-supervised modes, be periodically retrained using newly verified compliance outcomes, and can output confidence or explainability metadata.

Through this processing, service 105 clusters claims based on shared operational attributes, such as similarities in equipment usage, workflow conditions, environmental factors, or personnel activities. Service 105 then determines one or more causal nexuses that represent recurring operational conditions statistically correlated with multiple clustered claims, enabling identification of underlying contributors to loss rather than isolated incidents.

Based on the identified causal nexus, service 105 identifies one or more risk-mitigating procedures that are relevant to the organization. These procedures can be selected from a predefined library of operational controls that are associated with known loss-reduction outcomes or safety improvements. Service 105 can tailor the selection based on the organization’s industry, operational profile, or regulatory environment.

Service 105 then maps the identified risk-mitigating procedures to carrier-specific discount and credit rules (i.e. the discount-rule constraints 135) and to applicable regulatory requirements 130. This mapping produces a set of procedure-compliance obligations that define what actions must be performed, documented, or verified in order to reduce future risk exposure. In some cases, the obligations include measurable completion criteria, such as required frequencies, durations, or documented inspection results, allowing service 105 to later evaluate compliance in an objective and automated manner.

Service 105 updates the persistent risk-state data structure 115 to incorporate the causal nexus, the risk-mitigating procedures, and the procedure-compliance obligations as explicit state transitions. These transitions move the organization 110 from a first underwriting-risk state (i.e. a machine-interpretable state representing a level of underwriting readiness or compliance) to a second underwriting-risk state that reflects expected changes in risk based on planned or ongoing mitigation efforts. Service 105 can represent intermediate substates to capture partial completion or staged progress toward full compliance. In some implementations, updates to the risk-state data structure are triggered by receipt of new evidence, expiration of compliance intervals, or changes to regulatory or discount-rule datasets.

As the organization 110 performs the required procedures, service 105 receives compliance-evidence data 160 from one or more remote user devices. This evidence can include timestamped inspection records, task-completion confirmations, sensor-generated media, or other user-attributed operational evidence. In some implementations, the evidence also includes geolocation metadata or device-generated timestamps, which the service can use to associate evidence with specific locations, assets, or time windows.

Service 105 verifies the compliance-evidence data 160 against the stored regulatory requirements 130, the discount-rule constraints 135, and measurable completion criteria. This verification can include automated comparisons between evidence attributes and required thresholds or conditions. Based on the verification results, service 105 updates the persistent risk-state data structure 115 to reflect verified adherence or non-adherence, including transitions between discrete underwriting-risk substates that represent partial or complete compliance.

Verification can be implemented as adherence versus non-adherence. Some embodiments can implement progressive verification over time windows. Some embodiments can implement cross-validation between multiple evidence sources. Some embodiments can implement automated rejection or escalation of conflicting evidence.

Service 105 automatically generates an underwriting-ready representation 165 of the organization 110 based on the updated persistent risk-state data structure 115. This representation includes the identified causal nexus, the selected risk-mitigating procedures, verified adherence results, and an updated, machine-readable risk-state. Service 105 can generate this representation in a format configured for direct ingestion by underwriting systems without manual data re-entry, reducing downstream processing effort.

Service 105 also transmits the underwriting-ready representation 165 to a remote computing system used by an insurance underwriter. This transmission provides a continuously updated, evidence-supported explanation of the organization’s current risk profile, enabling underwriters to review verified operational changes alongside historical and regulatory context. Service 105 can repeat this process as new evidence or data becomes available, ensuring that the transmitted representation reflects the most current risk state.

In some embodiments, the disclosed service 105 provides mechanisms that enable policyholders or other authorized end users to directly request, obtain, and manage loss run data associated with one or more insurance policies without requiring mediation by an insurance broker or producer. This ability is not one that has historically been available to policyholders, so this ability provides substantial benefits to the policyholder.

Loss run data may include historical claims information, claim status, loss amounts, and related policy-specific records maintained by insurance carriers. Service 105 is configured to identify appropriate loss run data sources associated with a given policyholder, including carrier-specific endpoints, electronic submission channels, or designated loss run departments, and to facilitate transmission of requests for such data on behalf of the policyholder. In this manner, service 105 enables the policyholder to access claim history information that is otherwise fragmented across multiple carriers or administratively gated through third parties.

In some implementations, service 105 further aggregates, normalizes, and presents the obtained loss run data to the policyholder through a user-facing interface, allowing the policyholder to review, analyze, and reuse the loss run data for downstream insurance-related processes. For example, the loss run data may be structured in a standardized format suitable for submission to alternative carriers, underwriting systems, or risk assessment tools. By enabling direct acquisition and reuse of loss run data, service 105 reduces delays, minimizes redundant manual handling, and mitigates technical inefficiencies associated with carrier-by-carrier data retrieval processes.

In some embodiments, the disclosed functionality operates in conjunction with additional system features that assist the policyholder in understanding or contextualizing the loss run data, such as identifying eligibility for policy discounts, supporting preparation of explanatory information related to prior claims, or facilitating electronic transmission of loss run data to selected recipients. Service 105 thereby provides a technical infrastructure that improves data accessibility and portability of loss run information while maintaining compatibility with existing insurance carrier systems and workflows.

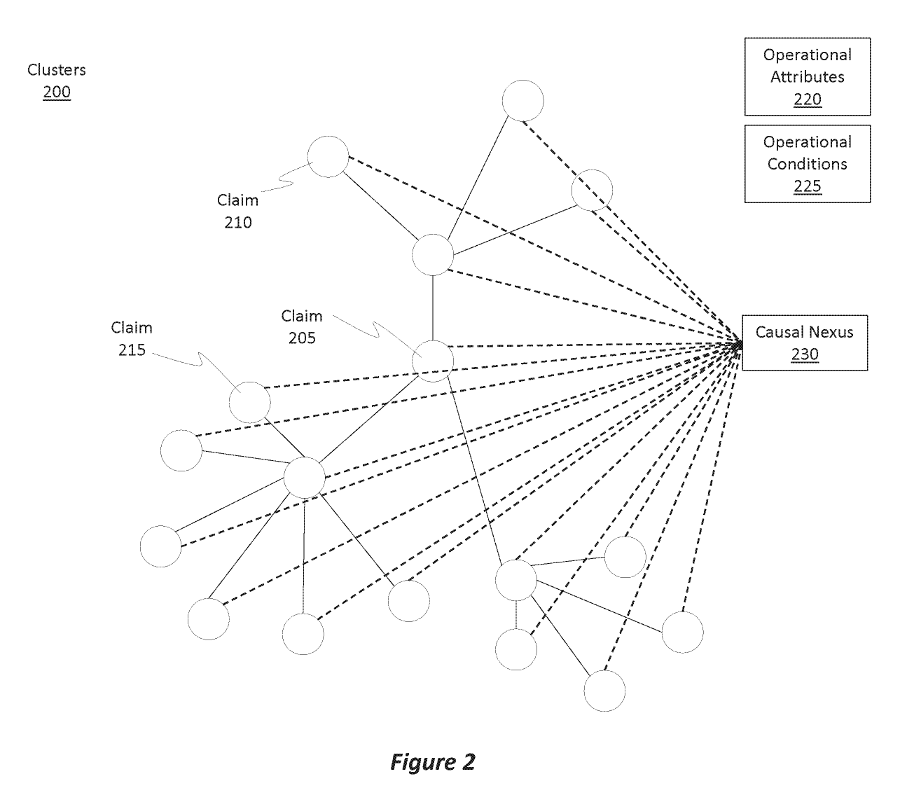

Having just described some of the features at a high level, attention will now be directed to FIGS. 2 through 11, which provide additional details, examples, and insights regarding the disclosure just presented.

FIG. 2 shows an example scenario in which different claims have been clustered together, as shown by clusters 200. For instance, in FIG. 2, the circles represent different claims that have been filed and that are included in the historical claim data 125 of FIG. 1. Three specific claims have been referenced, including claims 205, 210, and 215. The clusters 200 are groups of claims sharing common operational attributes.

At least some of the disclosed embodiments cluster claims (e.g., claims 205, 210, and 215) by analyzing claim records together with associated operational attributes 220 to identify shared characteristics that indicate common underlying operational conditions 225. Rather than treating each claim as an isolated event, service 105 evaluates multiple dimensions of operational context captured in the persistent risk-state data structure and in supplemental claim-explanation information. Using this information, service 105 groups claims that exhibit similar operational patterns, allowing service 105 to distinguish recurring operational issues from incidental or unrelated loss events. This clustering supports downstream analysis by reducing noise in the claim data and focusing attention on patterns that are meaningful from an operational and risk-management perspective.

The clustering process can consider operational attributes that describe how work was performed, under what conditions, and using which resources at the time of loss. Examples of operational attributes include types of equipment or machinery involved in a claim, maintenance status or inspection history of that equipment, workflow steps being performed when the loss occurred, staffing levels or personnel roles present at the time, environmental conditions such as temperature, lighting, or weather, and temporal factors such as time of day or shift schedules. Additional attributes can include the physical location of the activity, whether standardized procedures were in effect, and whether safety controls or protective measures were in use. These attributes can be derived from structured data fields, unstructured explanatory text, or a combination of both after normalization.

By clustering claims according to these operational attributes, service 105 can reveal groups of claims that share a common operational profile even when the claims differ in loss amount, claim category, or reporting format. For example, multiple claims occurring at different times can be clustered together based on shared equipment usage and similar workflow conditions, indicating a potential systemic issue with a particular process or asset. This approach enables the service to surface operational trends that are not apparent from loss-run data alone and provides a foundation for identifying underlying conditions that contribute to repeated claims. By clustering the claims, service 105 is able to identify a causal nexus 230.

Causal nexus 230, as it relates to the clustering of claims, represents an underlying operational condition or set of related conditions (e.g., operational conditions 225) that explains why multiple claims share similar operational patterns. After service 105 groups claims based on their shared operational attributes 220, the causal nexus 230 is identified as the common factor that contributes to the occurrence of those clustered claims, such as a recurring workflow practice, equipment usage pattern, environmental condition, or procedural gap. The causal nexus 230 links individual loss events to a broader operational cause rather than to isolated circumstances, allowing service 105 to associate the clustered claims with a specific condition that can be addressed or mitigated. By expressing the causal nexus 230 in this manner, service 105 provides a structured explanation of how repeated claims arise from the same operational source, supporting subsequent identification of corrective actions and evaluation of changes in risk over time. The following section provides a specific example illustrative of the above principles.

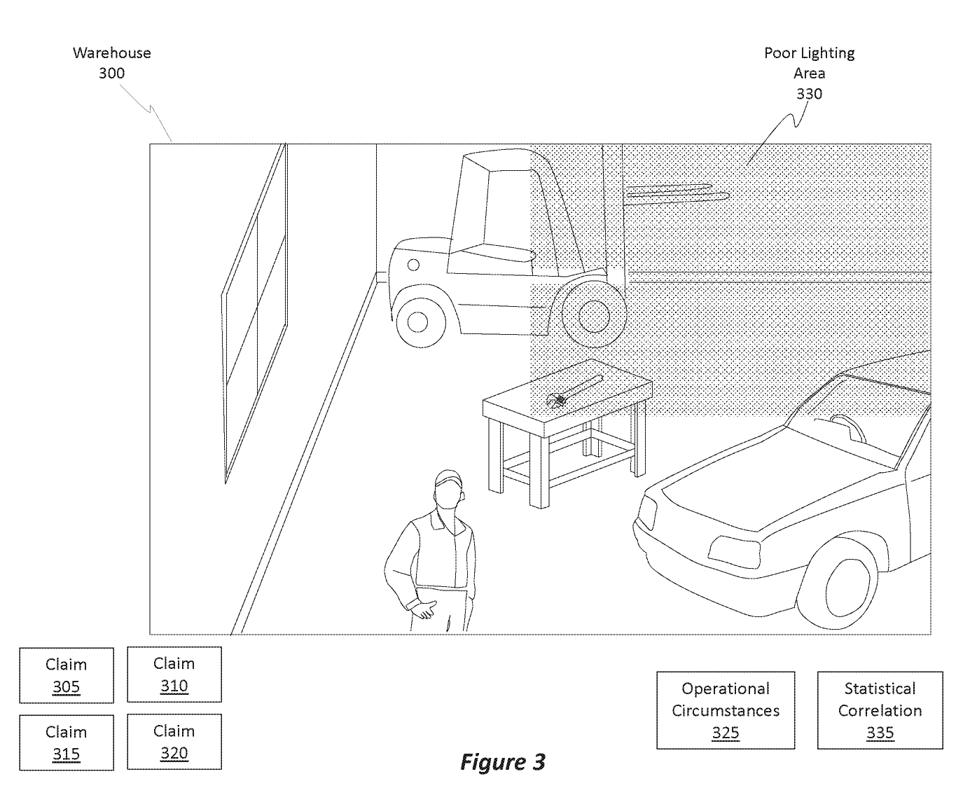

In one non-limiting example, service 105 processes historical workers’ compensation and general liability claims submitted by an organization operating multiple warehouse facilities, such as warehouse 300 illustrated in FIG. 3. FIG. 3 also shows the various different claims mentioned above, such as claims 305, 310, 315, and 320.

Loss-run records indicate several injury claims over a two-year period, including back strains, hand cuts, slips, and minor equipment-related injuries. On their face, the claims appear unrelated because they occurred on different dates, involve different employees, and are reported under different loss categories.

Service 105 supplements the loss-run data with claim-explanation information provided by the organization describing the operational circumstances 325 surrounding each claim, including the task being performed, the equipment in use, and the location within the facility.

Using this combined information, service 105 identifies that a subset of the claims share common operational attributes, including manual pallet handling in a specific loading zone, use of the same type of pallet jack, and occurrence during peak loading shifts. Service 105 clusters these claims together based on the shared operational pattern, even though the individual claims differ in severity and classification. Through this clustering, service 105 distinguishes the grouped claims as indicative of a recurring operational issue related to material-handling practices in that loading zone, rather than treating them as isolated or incidental loss events.

In contrast, service 105 separately identifies other claims in the loss history that do not share these operational attributes, such as a slip-and-fall occurring in an office area during a weather event or an injury caused by a one-time equipment malfunction that was promptly corrected. These claims are not included in the same cluster because they lack the shared operational characteristics. By grouping claims with similar operational patterns and excluding unrelated events, service 105 enables identification of systemic conditions contributing to repeated losses while filtering out incidental events that do not reflect ongoing operational risk.

Continuing the example above, after service 105 clusters the subset of injury claims associated with manual pallet handling in the same loading zone, service 105 evaluates the shared operational attributes to determine a causal nexus for the cluster. Based on the claim-explanation information and associated operational context, service 105 determines that the clustered claims are causally linked to a poorly lit area within the loading zone where the injuries occurred, as illustrated by poor lighting area 330. The inadequate lighting reduced visibility during pallet handling tasks, causing employees to misjudge distances, overlook obstructions, or improperly position equipment, which in turn contributed to repeated strain and impact injuries. By identifying poor lighting in that specific warehouse area as the causal nexus, service 105 associates the grouped claims with a concrete, underlying operational condition rather than with individual employee behavior or isolated accidents.

Service 105 uses statistical correlation 335 to evaluate whether clustered claims are meaningfully associated with shared operational attributes rather than occurring by chance. After grouping claims based on similarities in operational context, service 105 analyzes the frequency and co-occurrence of specific attributes—such as location, task type, equipment used, or environmental conditions—across the clustered claims and compares those patterns against baseline claim data. When the presence of a particular attribute, such as poor lighting in a defined warehouse area, exhibits a statistically significant relationship with the occurrence of multiple claims, service 105 treats that relationship as evidence supporting a causal nexus. This use of statistical correlation allows service 105 to distinguish recurring operational contributors to loss from incidental correlations, ensuring that identified causal nexuses are grounded in observable data patterns rather than anecdotal or isolated events. Machine learning and the LLM can be used to identify the causal nexus.

After identifying poor lighting in the loading zone as the causal nexus for the clustered injury claims, service 105 evaluates the nature of the underlying operational condition to determine appropriate risk-mitigating procedures. Service 105 analyzes the location, timing, and task context associated with the clustered claims to confirm that reduced visibility is consistently present during the relevant activities. Based on this analysis, service 105 determines that increasing illumination in the affected area directly addresses the identified causal nexus by improving employee visibility during pallet handling operations. As a result, service 105 identifies installation of additional lighting fixtures in the poorly lit loading zone as a risk-mitigating procedure relevant to the organization.

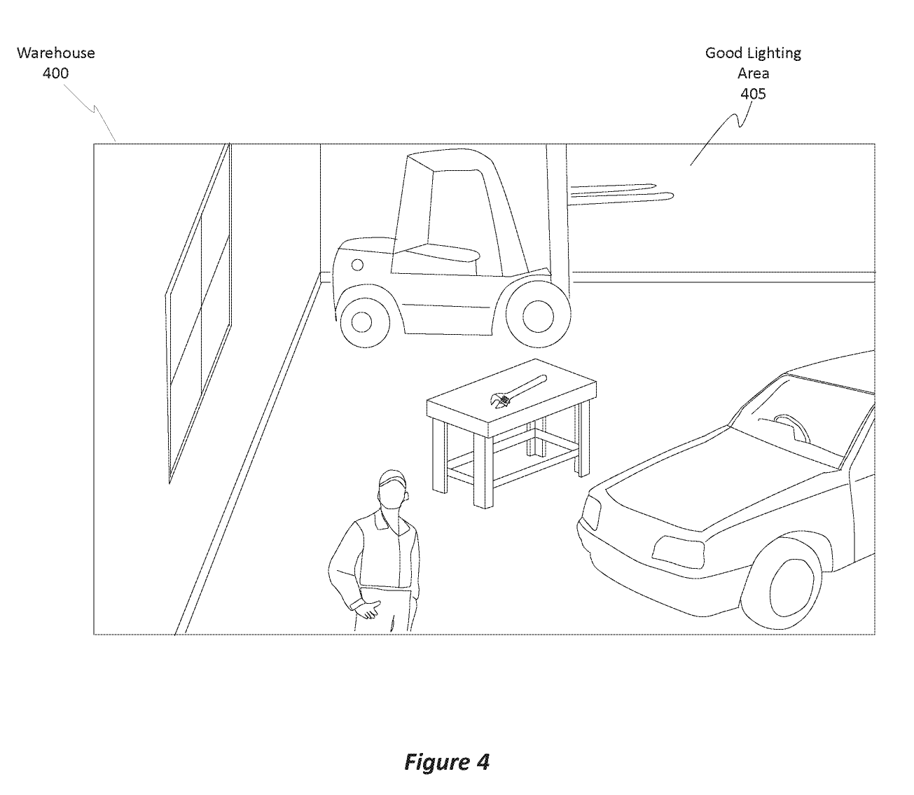

FIG. 4 shows warehouse 400, which is representative of warehouse 300 of FIG. 3. Here, however, proper lighting has been installed in the previous poor light area 330, as shown by the good lighting area 405, in response to the generation of the risk-mitigating procedure.

Service 105 further determines that addressing the causal nexus requires not only initial installation of lighting but also ongoing measures to ensure the lighting remains effective over time. To that end, service 105 identifies periodic inspection and maintenance of the installed lighting as an additional risk-mitigating procedure. This can include procedures for verifying that bulbs are operational, illumination levels meet defined thresholds, and fixtures remain unobstructed. The risk-mitigating procedure may involve the installation of a camera to monitor the area now illuminated to identify when the lighting burns out or is no longer on. By associating both installation and maintenance procedures with the identified causal nexus, service 105 treats risk mitigation as a sustained operational control rather than a one-time corrective action.

In identifying these risk-mitigating procedures, service 105 can also consider how the procedures align with existing operational practices and compliance frameworks applicable to the organization. For example, service 105 can associate lighting installation and maintenance with workplace safety requirements or internal facility standards already reflected in the risk-state data structure. This allows service 105 to select procedures that are not only responsive to the causal nexus but also compatible with the organization’s broader operational and compliance environment, supporting consistent implementation and verification over time.

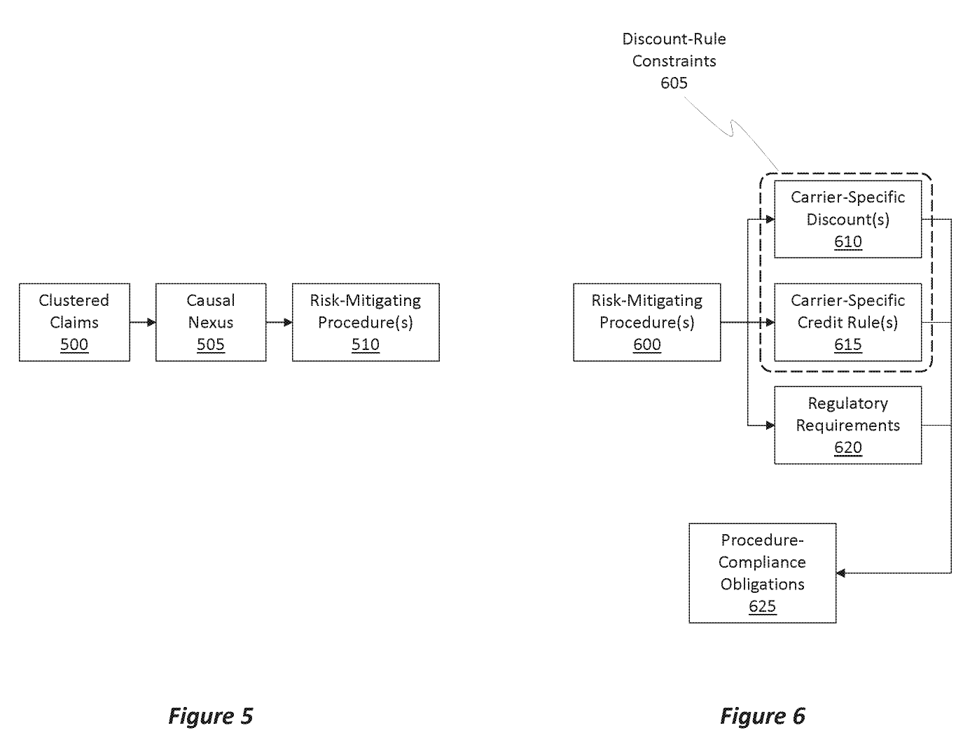

FIG. 5 illustrates an example stage in which service 105 transitions from analysis of clustered claims to identification of actionable risk mitigation and corresponding underwriting impacts. As shown, service 105 receives a set of clustered claims 500 that have been grouped based on shared operational attributes, as previously determined through analysis of historical claim data and associated claim-explanation information. From these clustered claims, service 105 determines a causal nexus 505, representing an underlying operational condition that contributes to the occurrence of the grouped claims. The causal nexus provides a structured explanation linking multiple loss events to a common operational cause rather than treating the claims as unrelated incidents.

Based on the identified causal nexus 505, service 105 determines one or more risk-mitigating procedures 510 that are relevant to addressing the underlying operational condition. These risk-mitigating procedures represent concrete actions or controls that can be implemented by the organization to reduce future loss exposure associated with the clustered claims. Service 105 can identify these procedures by evaluating the causal nexus in view of known operational controls, safety practices, or corrective measures that correspond to the type of condition identified. In some examples, the same or related risk-mitigating procedures can be associated with multiple causal nexuses, allowing service 105 to reuse or adapt procedures across different risk scenarios. For instance, the risk-mitigating procedure described in connection with FIG. 4 was the installation and maintenance of appropriate lighting so as to properly light the poor lighting area 330.

FIG. 6 further illustrates that service 105 maps the identified risk-mitigating procedures 600 to external underwriting-related frameworks, including discount-rule constraints 605 (which include carrier-specific discounts 610 and carrier-specific credit rules 615) and regulatory requirements 620. Through this mapping, service 105 determines how implementation of the risk-mitigating procedures 600 can affect underwriting considerations, such as eligibility for discounts, credits, or compliance recognition.

This mapping operation enables service 105 to connect operational improvements directly to underwriting outcomes, forming the basis for defining procedure-compliance obligations 625 (i.e. a set of machine-verifiable conditions derived from mapped procedures and rules) and subsequent verification steps illustrated in later figures. As a result, FIGS. 5 and 6 represent a notable transition point where analyzed claim data is transformed into structured, actionable mitigation paths that are aligned with both regulatory and carrier-specific underwriting criteria.

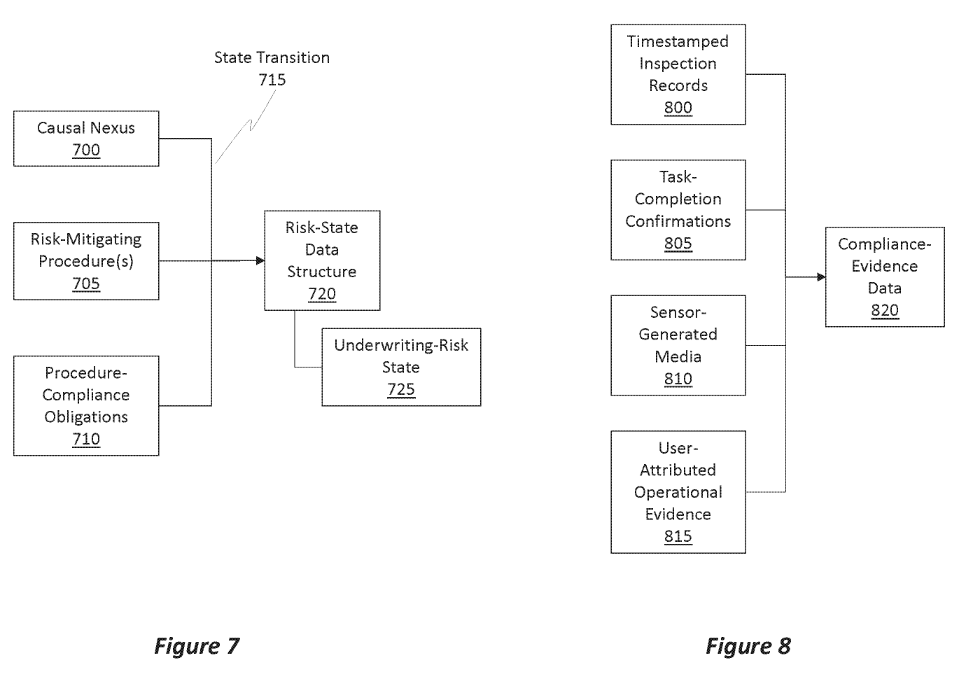

FIGS. 7 and 8 illustrate how service 105 manages state transitions within a persistent risk-state data structure and verifies compliance evidence associated with previously identified risk-mitigating procedures. As shown in FIG. 7, service 105 maintains a risk-state data structure 720 that stores a representation of the organization’s current underwriting-risk state. The risk-state data structure 720 includes information describing a causal nexus 700, one or more associated risk-mitigating procedures 705, and corresponding procedure-compliance obligations 710 derived from carrier-specific rules and regulatory requirements. Service 105 uses this information to trigger explicit state transitions 715 between underwriting-risk states, such as transitioning from an initial underwriting-risk state 725 to a subsequent state that reflects expected risk reduction based on implementation of the identified procedures.

The state transitions illustrated in FIG. 7 allow service 105 to treat underwriting risk as an evolving condition rather than a static assessment. Each underwriting-risk state can represent a distinct level of mitigation progress, such as an unmitigated state, a partially mitigated state, or a fully mitigated state. By encoding these states and transitions directly in the risk-state data structure 720, service 105 enables automated tracking of how operational changes affect underwriting posture over time. This approach also allows service 105 to preserve historical state information, supporting traceability and auditability of how and when risk conditions changed.

FIG. 8 illustrates how service 105 receives and evaluates compliance-evidence data 820 to determine whether the organization has satisfied the procedure-compliance obligations associated with a given underwriting-risk state. The compliance-evidence data can include multiple forms of electronically captured information, such as timestamped inspection records 800, task-completion confirmations 805, sensor-generated media 810, and other user-attributed operational evidence 815. Service 105 associates this evidence with specific risk-mitigating procedures and evaluates the evidence against stored regulatory requirements, discount-rule constraints, and measurable completion criteria defined in the risk-state data structure.

Examples of timestamped inspection records 800 include digitally generated inspection logs created during scheduled or ad hoc safety inspections. These can include a facility lighting inspection report indicating date and time of inspection, inspector identity, inspected locations, and measured illumination levels. Other examples include maintenance inspection records documenting verification of equipment condition at a specific time, third-party safety audit reports uploaded with time metadata, or mobile inspection forms completed on-site and automatically timestamped upon submission. In some cases, timestamped inspection records 800 also include versioned inspection checklists that reflect which inspection criteria were evaluated at the recorded time.

Examples of task-completion confirmations 805 include electronic acknowledgments indicating that a defined risk-mitigating task has been completed. These can include a work-order completion notice confirming installation of a lighting fixture, a digital sign-off confirming replacement of a failed bulb, or a system-generated confirmation that a scheduled maintenance task was marked complete within a required time window. Additional examples include confirmation messages generated by a maintenance management system, employee attestations submitted through a client interface, or automated completion signals generated when predefined task conditions are satisfied.

Examples of sensor-generated media 810 include images, video, or data streams captured by electronic sensors that document operational conditions. These can include photographs captured by a fixed or mobile camera showing an illuminated warehouse area, video recordings demonstrating lighting functionality during operational hours, or sensor data indicating measured light intensity levels at a specific location. Other examples include environmental sensor outputs capturing illumination changes over time, occupancy sensors correlating lighting usage with activity periods, or automated snapshots generated when sensor thresholds are met or violated.

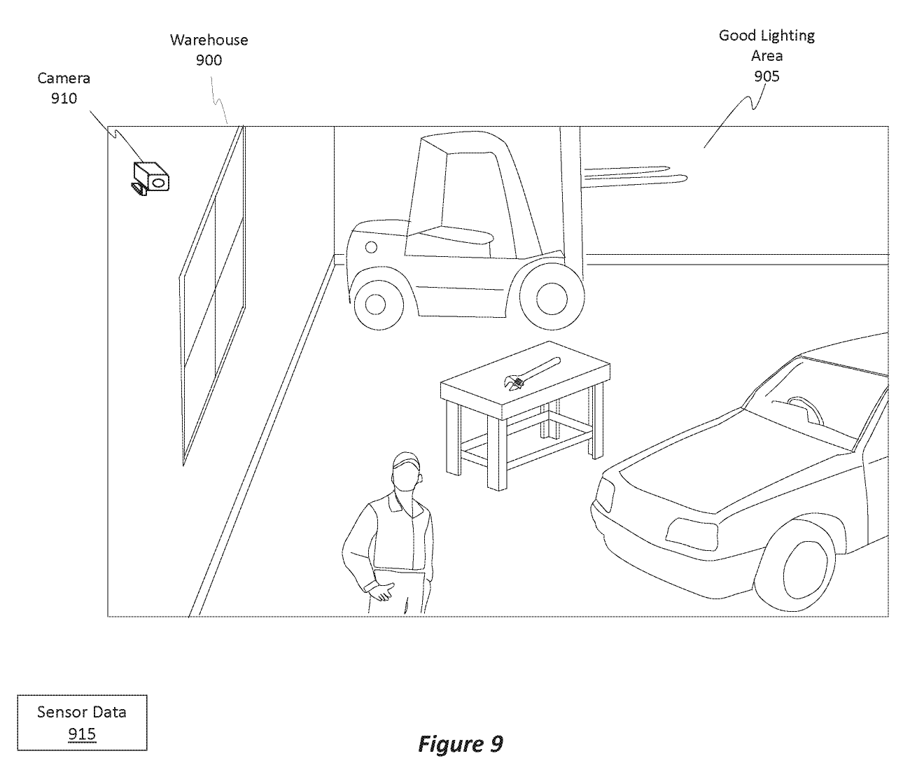

As a specific example, consider the disclosure presented in FIG. 9. FIG. 9 again shows the warehouse 900, which is representative of the warehouses mentioned earlier. Previously, proper lighting was installed to illuminate the poor lighting area 330, as shown by the good lighting area 905. Notice, a camera 910 is also installed, and this camera 910 is monitoring (among other things) the good lighting area 905 to ensure that the area continues to remain properly illuminated. Camera 910 generates sensor data 915, which can be included in the sensor-generated media 810 of FIG. 8.

Returning to FIG. 8, examples of other user-attributed operational evidence 815 include information provided by users that is electronically associated with an individual or role within the organization. This can include annotated photographs uploaded by a facility manager, written attestations describing corrective actions taken, or voice notes converted to text and linked to a compliance task. Additional examples include checklists completed by supervisors, digitally signed maintenance certifications, or explanatory comments submitted alongside sensor or inspection data to provide contextual clarification. In each case, the evidence is attributed to a specific user account or role, enabling service 105 to associate the evidence with responsibility and accountability for the corresponding risk-mitigating procedure.

Using a verification process, service 105 determines whether the received compliance-evidence data 820 demonstrates adherence or non-adherence to the procedure-compliance obligations 710. When adherence is verified, service 105 updates the risk-state data structure to reflect progression to a subsequent underwriting-risk state, such as a state representing partial or complete compliance. When non-adherence is identified, service 105 can maintain the current state or transition to an alternative state that reflects unmet obligations. By integrating evidence verification directly into state management, FIGS. 7 and 8 illustrate how service 105 provides a continuously updated, evidence-backed representation of underwriting risk that supports downstream generation of underwriting-ready representations and informed underwriting review.

Some embodiments are configured to determine how to evaluate whether partial compliance has been achieved. For instance, underwriting-risk states can include: confidence scores, completeness indicators, or evidence sufficiency thresholds. This information can be used to determine whether full or partial compliance has been achieved.

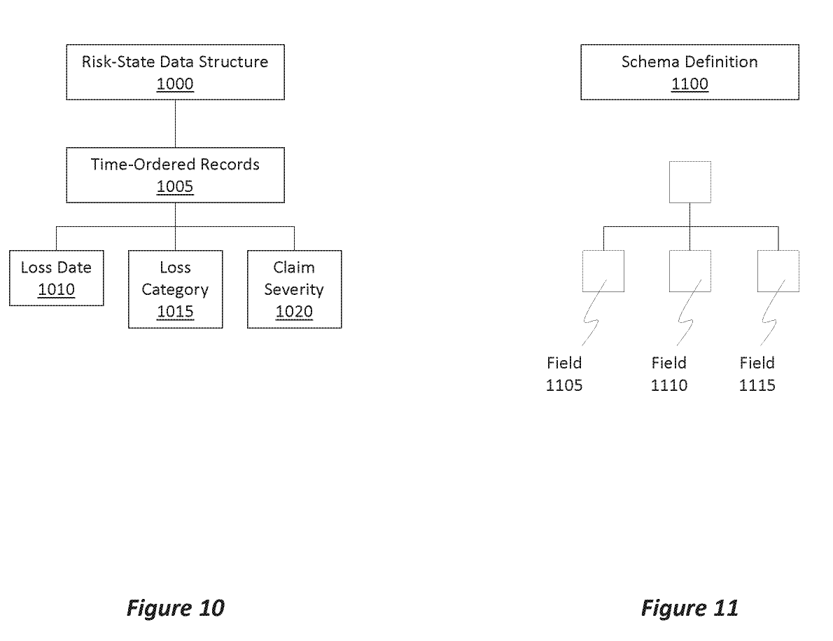

FIG. 10 illustrates an example structure of the persistent risk-state data structure 1000 maintained by service 105. As shown, service 105 stores risk-related information as time-ordered records 1005, allowing historical claim data to be organized chronologically rather than as isolated entries. Each record can include a loss date 1010, a loss category 1015, and a claim severity indicator 1020, enabling service 105 to associate temporal patterns with different types and magnitudes of loss events. By maintaining claim information in this structured, time-based manner, service 105 can evaluate trends over defined periods, correlate changes in operational conditions with changes in claim frequency or severity, and support analysis that depends on the sequencing of events rather than on aggregate summaries alone.

The time-ordered structure shown in FIG. 10 also supports downstream processing performed by service 105, such as clustering claims, identifying recurring operational conditions, and tracking how risk evolves over time. Because each record is stored in a standardized format with consistent fields, service 105 can efficiently traverse, filter, and process the records using automated logic without repeated normalization or manual interpretation. This structure further enables service 105 to preserve historical states of the risk-state data, supporting traceability and allowing later verification of how specific claims contributed to identified risk patterns or state transitions.

FIG. 11 illustrates an example schema definition 1100 used by service 105 to convert non-standardized input data into the standardized format of the persistent risk-state data structure. The schema definition includes predefined fields 1105, 1110, and 1115, each corresponding to a specific type of risk-related information expected by service 105. When risk-related information or claim-explanation information is received from different source platforms, service 105 uses the schema definition 1100 to map source-specific data elements into the appropriate standardized fields. This mapping process allows service 105 to integrate heterogeneous data sources into a single, coherent data structure suitable for automated analysis.

The schema definition 1100 shown in FIG. 11 also enables service 105 to apply validation and consistency checks during data ingestion. By defining expected data types, allowable values, and relationships between fields, the schema definition 1100 allows service 105 to detect incomplete, incompatible, or internally inconsistent data before it is stored in the persistent risk-state data structure 1000. This structured approach to data normalization and validation ensures that downstream operations—such as claim clustering, causal nexus identification, and compliance verification—operate on reliable and machine-readable data, thereby supporting accurate state transitions and generation of underwriting-ready representations.

In more detail, service 105 standardizes claim data by applying the predefined schema definition 1100, which converts heterogeneous claim inputs into a consistent, machine-readable format suitable for persistent storage and automated processing. Claim data can be received from multiple sources, including carrier loss-run records, third-party systems, and organization-supplied claim explanations, each of which can use different naming conventions, structures, and data representations. Using the schema definition 1100 illustrated in FIG. 11, service 105 identifies how source-specific fields correspond to standardized fields and maps incoming data elements accordingly. This mapping allows service 105 to normalize differences in format, terminology, and structure so that equivalent claim information is represented uniformly within the persistent risk-state data structure. Natural language processing can also be used during the standardization process.

As shown in FIG. 10, once mapped through the schema, standardized claim data is stored as time-ordered records. Each record includes defined attributes such as a loss date, a loss category, and a claim severity indicator. Service 105 derives these attributes by extracting and interpreting relevant information from the incoming data, populating the standardized fields defined in the schema. Organizing claims as time-ordered records enables service 105 to preserve the sequence of loss events and to support analyses that depend on temporal relationships, such as identifying changes in claim frequency or severity over time and correlating those changes with operational conditions.

During the standardization process, service 105 also enforces validation and consistency rules associated with the schema definition. These rules can specify required fields, allowable value ranges, data types, and relationships between fields, allowing service 105 to detect incomplete, incompatible, or internally inconsistent claim records before storage. When validation issues arise, service 105 can flag the affected records for supplementation or correction, or apply predefined normalization logic to resolve discrepancies. By combining schema-based field mapping, time-ordered structuring, and validation controls, service 105 produces standardized claim data that is reliable, comparable across sources, and optimized for downstream operations such as claim clustering, causal nexus identification, and underwriting risk-state management.

In some implementations, service 105 supports benchmarking across multiple organizations by analyzing anonymized risk-state data structures derived from different entities. Service 105 can normalize and aggregate selected attributes of underwriting-risk states, causal nexuses, and verified compliance outcomes while removing or obfuscating organization-identifying information. This allows service 105 to compute comparative metrics, such as relative frequency of certain causal nexuses or effectiveness of specific risk-mitigating procedures, without exposing sensitive operational details. The benchmarking results can be used to contextualize an organization’s current risk state relative to peer organizations operating in similar industries, geographies, or operational profiles, while maintaining data isolation and privacy controls.

In some implementations, service 105 supports simulation-based analysis by evaluating hypothetical risk-mitigating procedures that have not yet been implemented by the organization. Service 105 can temporarily apply simulated procedures to the persistent risk-state data structure and compute hypothetical state transitions based on stored regulatory requirements and discount-rule constraints. These simulated transitions allow service 105 to generate projected underwriting-risk states and potential compliance outcomes without modifying the organization’s active risk state. By enabling “what-if” analysis in this manner, service 105 allows organizations or underwriters to assess the potential impact of proposed operational changes before committing resources or performing physical modifications.

In some implementations, service 105 automatically manages expiration and validity windows associated with compliance-evidence data. Service 105 can track timestamps, inspection intervals, or duration-based requirements tied to procedure-compliance obligations and detect when previously verified evidence no longer satisfies those requirements. Upon detecting expiration or invalidation of evidence, service 105 can automatically roll back the persistent risk-state data structure to a prior underwriting-risk state or transition the organization to an alternate state reflecting reduced compliance. This automated rollback capability ensures that underwriting-risk states remain synchronized with current, valid evidence and prevents outdated confirmations from persisting indefinitely in the risk-state data structure.

In some implementations, service 105 normalizes discount-rule constraints across multiple insurance carriers to support consistent evaluation of risk-mitigating procedures. Service 105 can map carrier-specific discount and credit rules into a common intermediate representation that captures shared concepts such as incentive eligibility, documentation requirements, and verification thresholds. This normalization allows service 105 to evaluate a single set of risk-mitigating procedures against multiple carrier frameworks without duplicating analytical logic. As a result, service 105 can generate carrier-specific underwriting-ready representations from a unified risk-state data structure, enabling efficient comparison of underwriting outcomes across different insurance markets or carriers.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

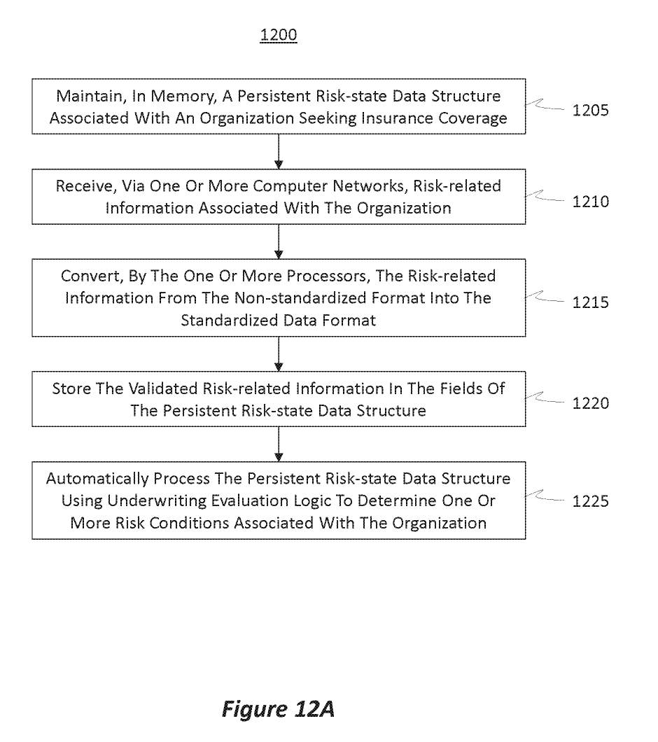

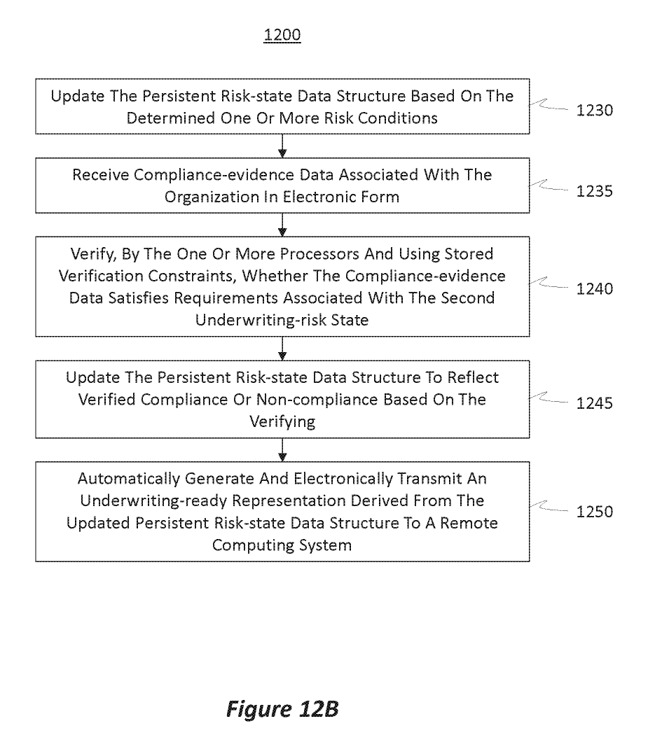

Attention will now be directed to FIGS. 12A and 12B, which illustrate flowcharts of an example method 1200 for generating a stateful, dynamically verifiable underwriting improvement model for an organization seeking insurance coverage. Method 1200 can be implemented within architecture 100 of FIG. 1 and by service 105.

In FIG. 12A, act 1205 includes maintaining, in memory, a persistent risk-state data structure associated with an organization seeking insurance coverage. The persistent risk-state data structure includes fields used to store risk-related data in a standardized data format.

In this act, service 105 initializes and maintains a digital data structure that persists across multiple processing cycles and system sessions. The persistent risk-state data structure serves as a central repository for risk-related information and is retained even when no active evaluation is occurring. Maintaining the data structure in memory enables low-latency access for subsequent operations and allows the data structure to function as a continuously evolving representation rather than a temporary working copy. In some implementations, the data structure is checkpointed or periodically synchronized with durable storage to preserve historical states.

Act 1210 includes receiving, via one or more computer networks, risk-related information associated with the organization. At least a portion of the risk-related information is received in a non-standardized format dependent on a source platform.

In this act, the disclosed embodiments accept incoming data transmitted over network connections from heterogeneous source platforms. The risk-related information can arrive asynchronously and can differ in structure, encoding, or semantic organization depending on the originating system. The embodiments can associate transport-level or application-level metadata with the received information to preserve context. This act enables ingestion of diverse data without requiring prior coordination among data providers.

Act 1215 includes converting, by the one or more processors, the risk-related information from the non-standardized format into the standardized data format, including validating the converted risk-related information against one or more data constraints defined for the standardized data format. In this act, the disclosed embodiments perform processor-executed transformations that reconcile differences between incoming data formats and the standardized format. Conversion can include reordering elements, normalizing values, or resolving ambiguities introduced by source-specific representations. Validation applies defined constraints that govern acceptable structure, value domains, or field relationships. This act ensures that only data conforming to the standardized representation progresses to subsequent stages.

Act 1220 includes storing the validated risk-related information in the fields of the persistent risk-state data structure. In this act, the disclosed embodiments write the validated data into designated fields of the persistent risk-state data structure. Storage can include associating the data with existing records or creating new entries within the data structure. The embodiments can preserve previous field values to allow comparison between earlier and later states. This act integrates newly received information into the ongoing risk representation for the organization.

Act 1225 includes automatically processing the persistent risk-state data structure using underwriting evaluation logic to determine one or more risk conditions associated with the organization. In this act, the disclosed embodiments apply underwriting evaluation logic directly to the contents of the persistent risk-state data structure. The logic can evaluate combinations of stored values to identify conditions that influence underwriting assessment. Processing occurs automatically as data becomes available or on a scheduled basis. The determined risk conditions are generated as structured outputs suitable for further machine processing.

In FIG. 12B, act 1230 includes updating the persistent risk-state data structure based on the determined one or more risk conditions, including updating the persistent risk-state data structure to reflect a transition from a first underwriting-risk state to a second underwriting-risk state. In this act, the disclosed embodiments encode the results of the underwriting evaluation back into the persistent risk-state data structure. Updating the data structure can include modifying state indicators that represent progression or regression in underwriting posture. The transition between underwriting-risk states captures a change in assessed risk rather than merely recording a descriptive label. This act allows the data structure itself to reflect the current underwriting status.

Act 1235 includes receiving compliance-evidence data associated with the organization in electronic form. In this act, the disclosed embodiments accept electronically generated evidence that corresponds to actions taken by the organization. The compliance-evidence data can be received after a risk-state transition or while a particular underwriting-risk state remains active. The data can be transmitted from distributed sources and does not require synchronized submission. This act enables later confirmation of whether organizational actions align with underwriting expectations.

Act 1240 includes verifying, by the one or more processors and using stored verification constraints, whether the compliance-evidence data satisfies requirements associated with the second underwriting-risk state. In this act, the disclosed embodiments evaluate the received compliance-evidence data against verification constraints stored in association with the underwriting-risk state. The verification constraints define objective conditions that must be met to satisfy the requirements of that state. Processor-executed verification produces a definitive outcome without reliance on subjective review. This act determines whether the organization has met the conditions necessary to support the updated underwriting status.

Act 1245 includes updating the persistent risk-state data structure to reflect verified compliance or non-compliance based on the verifying. In this act, the disclosed embodiments modify the persistent risk-state data structure to record the outcome of the compliance verification. This update can include marking compliance as satisfied, unmet, or pending further evidence. The updated data structure retains the verification result for use in later evaluations or reporting. This act ensures that compliance status is incorporated into the same stateful representation as other risk information.

Act 1250 includes automatically generating and electronically transmitting an underwriting-ready representation derived from the updated persistent risk-state data structure to a remote computing system. The underwriting-ready representation provides an up-to-date, machine-readable representation of the organization’s underwriting risk state.

In this act, the disclosed embodiments generate a representation that is directly derived from the current contents of the persistent risk-state data structure. The representation is machine-readable and structured to support automated ingestion by a remote computing system. Electronic transmission conveys the representation without manual intervention or reformatting. This act provides an external system with a current and consistent view of the organization’s underwriting risk state.

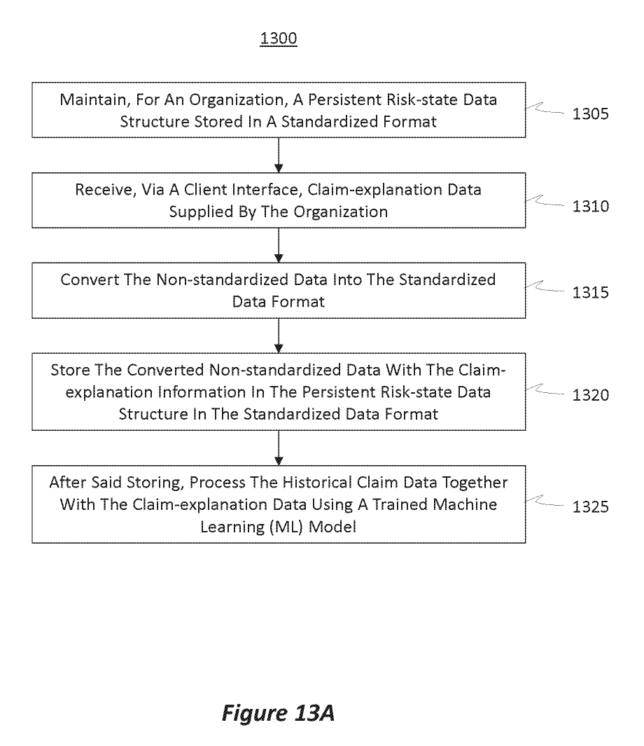

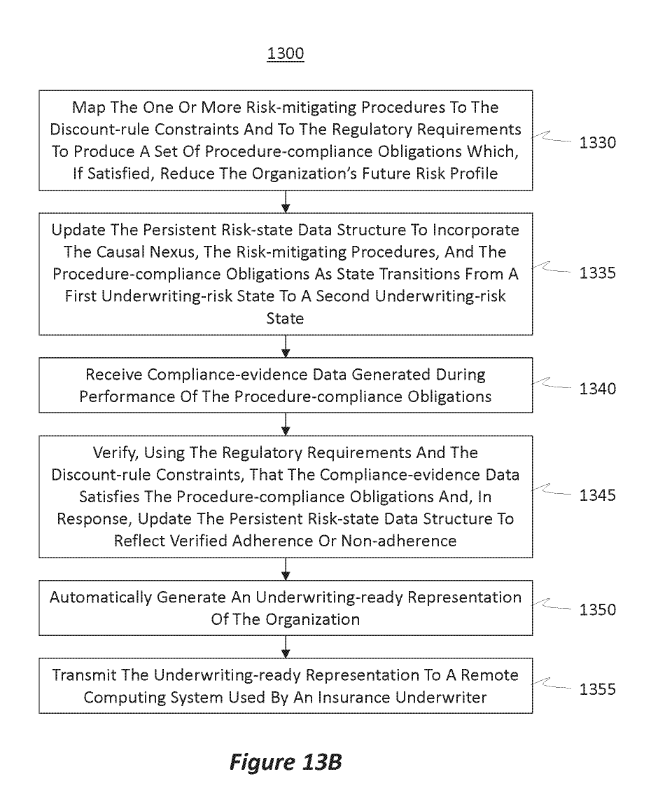

Attention will now be directed to FIGS. 13A and 13B. These figures illustrate another example method 1300 that can be performed by service 105 of FIG. 1.

Act 1305 includes maintaining, for the organization, a persistent risk-state data structure stored in a standardized format. The risk-state data structure includes historical claim data, regulatory requirements applicable to the organization, and discount-rule constraints obtained from curated, containerized datasets.

In this act, the disclosed embodiments establish and maintain a centralized data structure that serves as a long-lived representation of the organization’s underwriting-relevant risk information. The standardized format allows disparate types of information to coexist in a unified structure without ambiguity. Regulatory requirements and discount-rule constraints are incorporated alongside claim data so that analytical and evaluative operations can reference them without separate lookups. Using curated, containerized datasets allows the discount-rule constraints to be updated or replaced without restructuring the data model.

Act 1310 includes receiving, via a client interface, claim-explanation data supplied by the organization. The claim-explanation data describes operational circumstances surrounding individual historical claims and supplementing details absent from carrier-provided loss-run records, such that non-standardized data is received. At least a portion of the claim-explanation data is received in a non-standardized format dependent on a source platform, such that non-standardized data is received.

In this act, the disclosed embodiments accept explanatory information directly from organizational users through an interactive interface. The claim-explanation data can include narrative descriptions, contextual details, or operational observations that are not captured in traditional loss-run records. Because the data originates from different users or systems, at least some of it arrives in non-standardized formats. This act allows human-provided operational insight to be incorporated into automated risk analysis.

Act 1315 includes converting the non-standardized data into the standardized data format, including validating the converted non-standardized data against one or more data constraints of the standardized data format. In this act, the disclosed embodiments transform the received claim-explanation data into a consistent representation that matches the standardized format of the persistent risk-state data structure. Conversion can include restructuring free-form inputs, normalizing terminology, or aligning values with predefined categories. Validation checks confirm that the converted data satisfies required structural and semantic constraints. This act ensures that explanatory data can be processed together with structured claim data without introducing inconsistencies.

Act 1320 includes storing the converted non-standardized data with the claim-explanation information in the persistent risk-state data structure in the standardized data format. In this act, the disclosed embodiments integrate the normalized claim-explanation data into the persistent risk-state data structure alongside historical claim data. The storage operation preserves associations between individual claims and their corresponding explanations. This enables subsequent analytical operations to consider both quantitative claim attributes and qualitative operational context. Storing the data in standardized form allows it to be reused across multiple processing stages.

Act 1325 includes processing (e.g., after the storing mentioned above) the historical claim data together with the claim-explanation data using a trained machine learning model to perform a number of operations. One operation involves clustering claims according to shared operational attributes. Another operation involves determining at least one causal nexus. Another operation involves identifying one or more risk-mitigating procedures relevant to the organization.

In this act, the disclosed embodiments apply a trained machine learning model to analyze combined claim and explanation data. The model groups claims that share similar operational characteristics, revealing patterns that may not be evident from loss data alone. Based on these groupings, the model identifies a causal nexus that represents an underlying operational condition contributing to multiple claims. The model then associates the causal nexus with risk-mitigating procedures that address the identified condition.

Act 1330 includes mapping the one or more risk-mitigating procedures to the discount-rule constraints and to the regulatory requirements to produce a set of procedure-compliance obligations which, if satisfied, reduce the organization’s future risk profile. In this act, the disclosed embodiments align the identified risk-mitigating procedures with applicable regulatory requirements and discount-rule constraints stored in the risk-state data structure. This mapping determines how specific operational actions correspond to compliance expectations and potential underwriting incentives. The resulting procedure-compliance obligations define concrete conditions that can be verified electronically. This act connects operational remediation directly to underwriting considerations.

Act 1335 includes updating the persistent risk-state data structure to incorporate the causal nexus, the risk-mitigating procedures, and the procedure-compliance obligations as state transitions from a first underwriting-risk state to a second underwriting-risk state. In this act, the disclosed embodiments encode the results of the analysis and mapping into the persistent risk-state data structure as explicit state transitions. Each underwriting-risk state represents a distinct stage of mitigation or compliance progress. Recording transitions allows the data structure to capture how risk evolves over time rather than merely storing static attributes. This state-based representation supports later verification and reporting.

Act 1340 includes receiving compliance-evidence data generated during performance of the procedure-compliance obligations. The compliance-evidence data includes timestamped inspection records, task-completion confirmations, sensor-generated media, or other user-attributed operational evidence.

In this act, the disclosed embodiments collect electronic evidence produced as the organization carries out the required risk-mitigating procedures. The evidence can take multiple forms and can be generated by different systems or users. Receiving diverse evidence types allows the embodiments to accommodate a wide range of operational environments. This act enables ongoing monitoring rather than one-time confirmation.

Act 1345 includes verifying, using the regulatory requirements and the discount-rule constraints, that the compliance-evidence data satisfies the procedure-compliance obligations and, in response, updating the persistent risk-state data structure to reflect verified adherence or non-adherence. In this act, the disclosed embodiments evaluate the received compliance-evidence data against stored requirements and constraints. Verification confirms whether the evidence demonstrates that the procedure-compliance obligations have been met. Based on the outcome, the persistent risk-state data structure is updated to reflect adherence or non-adherence. This update directly affects the organization’s underwriting-risk state.

Act 1350 includes automatically generating an underwriting-ready representation of the organization. The underwriting-ready representation includes the causal nexus, the risk-mitigating procedures, verified adherence results, and an updated, machine-readable risk-state derived from the persistent risk-state data structure.

In this act, the disclosed embodiments compile selected elements of the risk-state data structure into a coherent representation suitable for underwriting review. The representation summarizes both the causes of past risk and the organization’s response to those causes. Generating the representation automatically ensures consistency with the current risk-state data structure. The machine-readable format allows downstream systems to process the representation without manual interpretation.

Act 1355 includes transmitting the underwriting-ready representation to a remote computing system used by an insurance underwriter, thereby providing a continuously updated, evidence-supported explanation of the organization’s current risk profile. In this act, the disclosed embodiments transmit the underwriting-ready representation over a network to a remote system. The transmission enables underwriters to access a current view of the organization’s risk that reflects verified operational changes. Because the representation is derived from the persistent risk-state data structure, it reflects the most recent state transitions and evidence. This act supports informed underwriting decisions based on continuously updated data.

Accordingly, the disclosed embodiments address technical and operational problems that arise when risk-related information used for insurance underwriting is fragmented, inconsistently formatted, and evaluated only at isolated points in time. Traditional systems struggle to integrate heterogeneous data sources, capture operational context behind loss events, and maintain an accurate, verifiable representation of how risk changes as organizations take corrective actions. As a result, underwriting assessments can become stale, opaque, and disconnected from actual operational improvements, while evidence of compliance or mitigation is difficult to track, validate, and relate back to underwriting outcomes.

To address these issues, the disclosed embodiments provide a computer-implemented approach that standardizes disparate risk-related inputs into a persistent, machine-readable risk-state data structure and treats underwriting assessment as an evolving, state-driven process. The embodiments combine historical claim data with organization-supplied operational explanations, apply automated analysis to identify underlying causes of repeated claims, and associate those causes with concrete risk-mitigating procedures. By mapping those procedures to regulatory requirements and underwriting constraints, and by verifying electronic evidence of compliance, the embodiments continuously update the organization’s underwriting-risk state in a structured and traceable manner.

The disclosed embodiments deliver technical benefits by improving how computer systems ingest, normalize, store, and process risk-related data over time. Persistent risk-state management reduces redundant computation and enables efficient state transitions rather than repeated full reassessments. Automated validation, verification, and machine-readable representations improve data integrity, reduce latency in communicating risk changes, and support seamless integration with downstream underwriting systems. Collectively, these features provide a practical, technology-driven solution that enhances the reliability, efficiency, and transparency of underwriting-related risk evaluation while remaining grounded in concrete changes to data structures, processing flows, and system behavior.

At least some of the disclosed embodiments provide computing-based advantages by enabling incremental and event-driven updates to underwriting evaluations rather than requiring batch re-computation across entire datasets. By structuring underwriting assessment around a persistent risk-state data structure, the embodiments can process newly received or modified data, such as updated evidence or explanatory inputs, and apply targeted state transitions. This reduces processor utilization and memory access overhead compared to systems that repeatedly re-evaluate complete claim histories. The approach also supports parallel processing, allowing different aspects of the risk state—such as compliance verification and claim analysis—to be updated independently and asynchronously, improving overall system throughput and responsiveness.

Additional practical applications arise from the way the disclosed embodiments manage data provenance and traceability within the risk-state data structure. By retaining associations between raw inputs, derived analytical results, and subsequent state transitions, the embodiments enable precise tracking of how specific data inputs influence underwriting outcomes. This structured lineage reduces the need for manual audits or reconciliation processes and supports automated rollback or re-evaluation when source data changes or is corrected. From a system perspective, this improves fault tolerance and simplifies error handling, as the computing environment can selectively recompute affected portions of the risk state without disrupting unrelated data or processes.

Given the sensitivity of underwriting data, some embodiments operate to ensure certain data governance requirements are satisfied. For instance, some embodiments implement role-based access to portions of the risk-state data structure. Some embodiments provide cryptographic hashing or signing of evidence records. Additionally, some embodiments maintain audit trails for state transitions.

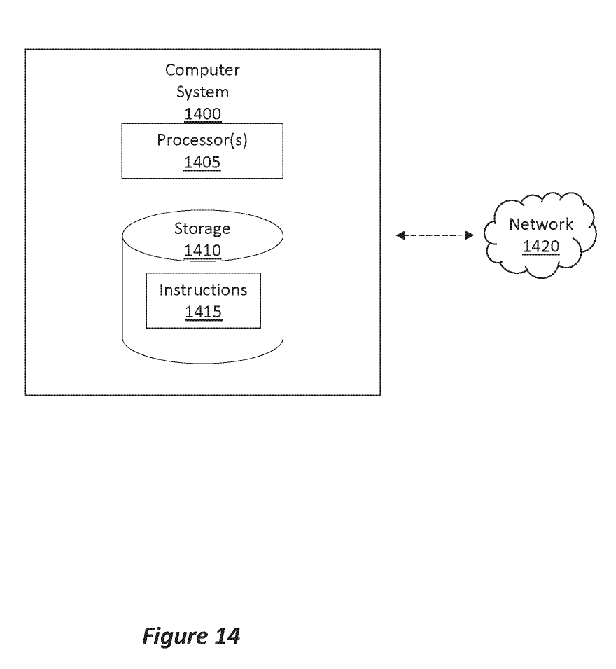

Attention will now be directed to FIG. 14 which illustrates an example computer system 1400 that may include and/or be used to perform any of the operations described herein. Computer system 1400 can implement service 105 of FIG. 1. Computer system 1400 may take various different forms. For example, computer system 1400 may be embodied as a tablet, a desktop, a laptop, a mobile device, or a standalone device, such as those described throughout this disclosure. Computer system 1400 may also be a distributed system that includes one or more connected computing components/devices that are in communication with computer system 1400.

In its most basic configuration, computer system 1400 includes various different components. FIG. 14 shows that computer system 1400 includes one or more processor(s) 1405 (aka a “hardware processing unit”) and storage 1410.

Regarding the processor(s) 1405, it will be appreciated that the functionality described herein can be performed, at least in part, by one or more hardware logic components (e.g., the processor(s) 1405). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computer system 1400. The different components, modules, engines, and services described herein may be implemented as objects or processors that execute on computer system 1400 (e.g. as separate threads).

Storage 1410 may be physical system memory, which may be volatile, non-volatile, or some combination of the two. The term “memory” may also be used herein to refer to non-volatile mass storage such as physical storage media. If computer system 1400 is distributed, the processing, memory, and/or storage capability may be distributed as well.

Storage 1410 is shown as including executable instructions 1415. The executable instructions 1415 represent instructions that are executable by the processor(s) 1405 of computer system 1400 to perform the disclosed operations, such as those described in the various methods.

The disclosed embodiments may comprise or utilize a special-purpose or general-purpose computer including computer hardware, such as, for example, one or more processors (such as processor(s) 1405) and system memory (such as storage 1410), as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 1400 may also be connected (via a wired or wireless connection) to external sensors (e.g., one or more remote cameras) or devices via a network 1420. For example, computer system 1400 can communicate with any number devices or cloud services to obtain or process data. In some cases, network 1420 may itself be a cloud network. Furthermore, computer system 1400 may also be connected through one or more wired or wireless networks to remote/separate computer systems(s) that are configured to perform any of the processing described with regard to computer system 1400.

A “network,” like network 1420, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 1400 will include one or more communication channels that are used to communicate with the network 1420. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. It should also be noted how any feature recited herein can be combined with any other feature recited herein.

What is claimed is:

1. A computer-implemented method, executed by one or more processors, comprising:
maintaining, in memory, a persistent risk-state data structure associated with an organization seeking insurance coverage, the persistent risk-state data structure comprising fields storing risk-related data in a standardized data format;
receiving, via one or more computer networks, risk-related information associated with the organization, wherein at least a portion of the risk-related information is received in a non-standardized format dependent on a source platform;
converting, by the one or more processors, the risk-related information from the non-standardized format into the standardized data format, including validating the converted risk-related information against one or more data constraints defined for the standardized data format;
storing the validated risk-related information in the fields of the persistent risk-state data structure;
automatically processing the persistent risk-state data structure using underwriting evaluation logic to determine one or more risk conditions associated with the organization;
updating the persistent risk-state data structure based on the determined one or more risk conditions, including updating the persistent risk-state data structure to reflect a transition from a first underwriting-risk state to a second underwriting-risk state;
receiving compliance-evidence data associated with the organization in electronic form;
verifying, by the one or more processors and using stored verification constraints, whether the compliance-evidence data satisfies requirements associated with the second underwriting-risk state;
updating the persistent risk-state data structure to reflect verified compliance or non-compliance based on the verifying; and
automatically generating and electronically transmitting an underwriting-ready representation derived from the updated persistent risk-state data structure to a remote computing system, the underwriting-ready representation providing an up-to-date, machine-readable representation of the organization’s underwriting risk state.

2. The method of claim 1, wherein the risk-related information includes historical loss information associated with the organization, and wherein the persistent risk-state data structure stores the historical loss information together with supplemental explanatory information describing circumstances associated with one or more historical loss events.

3. The method of claim 1, wherein validating the converted risk-related information against the one or more data constraints includes enforcing consistency constraints across multiple fields of the persistent risk-state data structure to prevent storage of internally inconsistent risk-related data values.

4. The method of claim 1, wherein automatically processing the persistent risk-state data structure using underwriting evaluation logic includes comparing stored risk-related data against regulatory requirements applicable to the organization to determine at least one compliance-related risk condition.

5. The method of claim 1, wherein the compliance-evidence data includes electronically captured records generated during performance of one or more risk-mitigating procedures, the records comprising at least one of timestamped inspection data, task-completion confirmations, or user-attributed operational evidence.

6. The method of claim 1, wherein the underwriting-ready representation excludes insurance pricing or premium determination and is configured to provide an evidence-supported explanation of the organization’s current underwriting risk state for review by an insurance underwriter.

7. A computer‑implemented method for generating a stateful, dynamically verifiable underwriting improvement model for an organization seeking insurance coverage, the method executed by one or more processors and comprising:
maintaining, for the organization, a persistent risk‑state data structure stored in a standardized format, the risk‑state data structure comprising (i) historical claim data, (ii) regulatory requirements applicable to the organization, and (iii) discount-rule constraints obtained from curated, containerized datasets;
receiving, via a client interface, claim‑explanation data supplied by the organization, the claim‑explanation data describing operational circumstances surrounding individual historical claims and supplementing details absent from carrier‑provided loss‑run records, wherein at least a portion of the claim-explanation data is received in a non-standardized format dependent on a source platform, such that non-standardized data is received;
converting the non-standardized data into the standardized data format, including validating the converted non-standardized data against one or more data constraints of the standardized data format;
storing the converted non-standardized data with the claim-explanation information in the persistent risk-state data structure in the standardized data format;
after said storing, processing the historical claim data together with the claim‑explanation data using a trained machine learning (ML) model to:
(i) cluster claims according to shared operational attributes,
(ii) determine at least one causal nexus representing an underlying operational condition contributing to the clustered claims, and
(iii) identify, based on the causal nexus, one or more risk‑mitigating procedures relevant to the organization;
mapping the one or more risk‑mitigating procedures to the discount-rule constraints and to the regulatory requirements to produce a set of procedure‑compliance obligations which, if satisfied, reduce the organization’s future risk profile;
updating the persistent risk‑state data structure to incorporate the causal nexus, the risk‑mitigating procedures, and the procedure‑compliance obligations as state transitions from a first underwriting‑risk state to a second underwriting‑risk state;
receiving compliance‑evidence data generated during performance of the procedure‑compliance obligations, the compliance‑evidence data comprising timestamped inspection records, task‑completion confirmations, sensor‑generated media, or other user‑attributed operational evidence;
verifying, using the regulatory requirements and the discount‑rule constraints, that the compliance‑evidence data satisfies the procedure‑compliance obligations and, in response, updating the persistent risk‑state data structure to reflect verified adherence or non‑adherence;
automatically generating an underwriting‑ready representation of the organization, the underwriting‑ready representation comprising (i) the causal nexus, (ii) the risk‑mitigating procedures, (iii) verified adherence results, and (iv) an updated, machine‑readable risk‑state derived from the persistent risk‑state data structure; and
transmitting the underwriting‑ready representation to a remote computing system used by an insurance underwriter, thereby providing a continuously updated, evidence‑supported explanation of the organization’s current risk profile.

8. The method of claim 7, wherein the persistent risk-state data structure stores the historical claim data as time-ordered records, each record including a loss date, loss category, and claim severity indicator.

9. The method of claim 7, wherein the regulatory requirements applicable to the organization include jurisdiction-specific safety, reporting, or operational standards encoded as machine-readable compliance rules.

10. The method of claim 7, wherein the curated, containerized datasets comprising the carrier-specific discount and credit rules are versioned datasets, and wherein the method further comprises selecting a dataset version based on an applicable insurance carrier or coverage type.

11. The method of claim 7, wherein converting the non-standardized data into the standardized data format includes mapping source-specific data fields to predefined standardized fields using a stored schema definition.

12. The method of claim 7, wherein validating the converted non-standardized data includes enforcing cross-field consistency constraints that prevent storage of mutually incompatible risk attributes within the persistent risk-state data structure.

13. The method of claim 7, wherein the trained AI model is trained using historical claim datasets associated with multiple organizations and labeled with operational attributes corresponding to prior loss events.

14. The method of claim 7, wherein clustering the claims according to shared operational attributes includes grouping claims based on similarities in equipment usage, workflow conditions, environmental factors, or personnel activities.

15. The method of claim 7, wherein determining the at least one causal nexus includes identifying a recurring operational condition statistically correlated with multiple clustered claims.

16. The method of claim 7, wherein identifying the one or more risk-mitigating procedures includes selecting procedures from a predefined library of operational controls associated with known loss-reduction outcomes.

17. The method of claim 7, wherein mapping the one or more risk-mitigating procedures to the carrier-specific discount and credit rules includes identifying incentive eligibility conditions associated with verified implementation of the procedures.

18. The method of claim 7, wherein the procedure-compliance obligations include measurable completion criteria defined by at least one of a required frequency, duration, or documented inspection result.

19. The method of claim 7, wherein the compliance-evidence data further comprises geolocation metadata or device-generated timestamps associated with performance of the procedure-compliance obligations.

20. The method of claim 7, wherein verifying that the compliance-evidence data satisfies the procedure-compliance obligations includes automatically comparing the compliance-evidence data against the measurable completion criteria stored in the persistent risk-state data structure.

21. The method of claim 7, wherein updating the persistent risk-state data structure to reflect verified adherence or non-adherence includes transitioning the organization between discrete underwriting-risk substates representing partial or complete compliance.

22. The method of claim 7, wherein the underwriting-ready representation is generated in a machine-readable format configured for ingestion by an underwriting system without manual re-entry of data.

23. A computer system comprising:
one or more processors; and
one or more hardware storage devices that store instructions that are executable by the one or more processors to cause the computer system to:
maintain, for an organization, a persistent risk‑state data structure stored in a standardized format, the risk‑state data structure comprising (i) historical claim data, (ii) regulatory requirements applicable to the organization, and (iii) discount-rule constraints obtained from curated, containerized datasets;
receive, via a client interface, claim‑explanation data supplied by the organization, the claim‑explanation data describing operational circumstances surrounding individual historical claims and supplementing details absent from carrier‑provided loss‑run records, wherein at least a portion of the claim-explanation data is received in a non-standardized format dependent on a source platform, such that non-standardized data is received;
convert the non-standardized data into the standardized data format, including validating the converted non-standardized data against one or more data constraints of the standardized data format;
store the converted non-standardized data with the claim-explanation information in the persistent risk-state data structure in the standardized data format;
after said storing, process the historical claim data together with the claim‑explanation data using a trained machine learning (ML) model to:
(i) cluster claims according to shared operational attributes,
(ii) determine at least one causal nexus representing an underlying operational condition contributing to the clustered claims, and
(iii) identify, based on the causal nexus, one or more risk‑mitigating procedures relevant to the organization;
map the one or more risk‑mitigating procedures to the discount-rule constraints and to the regulatory requirements to produce a set of procedure‑compliance obligations which, if satisfied, reduce the organization’s future risk profile;
update the persistent risk‑state data structure to incorporate the causal nexus, the risk‑mitigating procedures, and the procedure‑compliance obligations as state transitions from a first underwriting‑risk state to a second underwriting‑risk state;
receive compliance‑evidence data generated during performance of the procedure‑compliance obligations, the compliance‑evidence data comprising timestamped inspection records, task‑completion confirmations, sensor‑generated media, or other user‑attributed operational evidence;
verify, using the regulatory requirements and the discount‑rule constraints, that the compliance‑evidence data satisfies the procedure‑compliance obligations and, in response, update the persistent risk‑state data structure to reflect verified adherence or non‑adherence;
automatically generate an underwriting‑ready representation of the organization, the underwriting‑ready representation comprising (i) the causal nexus, (ii) the risk‑mitigating procedures, (iii) verified adherence results, and (iv) an updated, machine‑readable risk‑state derived from the persistent risk‑state data structure; and
transmit the underwriting‑ready representation to a remote computing system used by an insurance underwriter, thereby providing a continuously updated, evidence‑supported explanation of the organization’s current risk profile.
